(19) United States
(12) Patent Application Publication
(10) Pub. No.: US 2023/0107184 A1
(43) Pub. Date: Apr. 6, 2023

(54) APPARATUS AND METHOD FOR 3D TEXT MESSAGING SERVICE

(71) Applicant: IMMERSIVECAST CO., LTD., Seongnam-si (KR)

(72) Inventors: Jang Hee HAN, Seongnam-si (KR); Jae Hyeon JOO, Suwon-si (KR)

(73) Assignee: IMMERSIVECAST CO., LTD., Seongnam-si (KR)

(21) Appl. No.: 17/864,437

(22) Filed: Jul. 14, 2022

(30) Foreign Application Priority Data
Sep. 24, 2021 (KR) 10-2021-0126465

(51) Int. Cl. G06T 19/00; G06F 40/205; G06F 40/279

(52) U.S. Cl. CPC G06T 19/006; G06F 40/205; G06F 40/279

(57) ABSTRACT

The present disclosure relates to an apparatus and a method for a 3D text messaging service, the apparatus including a text analyzer analyzing a text message input and transmitted through a sender terminal and recognizing text content and message context; an associated image generator determining an image associated with the recognized message context and generating an image associated with the text message; an effect generator generating a 3D effect to be included in the text and associated image according to the recognized text content; and an XR message converter integrating the text, the associated image, and the 3D effect, converting the integrated content into an extended reality (XR) message, and providing the XR message to a receiver terminal.

### BACKGROUND OF THE DISCLOSURE

### Field of the Disclosure

The present disclosure relates to a text messaging service technology and, more particularly, to an apparatus and a method for a 3D text messaging service capable of converting an ordinary text message into a 3D message and providing the converted 3D message.

### Related Art

Virtual Reality (VR) is a computer graphics technology that provides real-world objects or scenes only in the form of computer graphics (CG) images. In contrast, Augmented Reality (AR) technology provides virtual CG images on top of actual object images. Mixed Reality (MR) technology merges the real world with virtual objects to provide a mixed environment. VR, AR, and MR will all be referred to as extended reality (XR) technology.

Meanwhile, the messenger is software that allows users to exchange messages and data in real-time on the Internet. A user may register a chat partner and transmit and receive messages with the other person on a chat partner list displayed on a messenger screen. Messenger software is widely used these days not only for a PC environment but also for a mobile environment based on mobile communication terminals.

In the past, most messengers performed text-oriented communication based on a combination of letters, symbols, and numbers, thereby being limited in expressing a user's emotions. To overcome the limitation, messengers nowadays use images such as emoticons or stickers in addition to the text to express a user's feelings or situation.

However, since the conventional use of emoticons or stickers relies on a method in which a user expresses his or her feelings to the other party by selecting a desired sample from among the samples provided by a messenger service provider, the other party may consider it a little hackneyed when the same sample is used repeatedly and find it difficult to properly notice the expression or emotion related to the content of a message written by the user.

Therefore, there arose a need for a new message expression technique capable of properly conveying a text message's meaning to the other party.

### PRIOR ART REFERENCES

### Patents

(Patent 0001) Korean registered patent, No. 10-2014778 (2019.08.21)

### SUMMARY OF THE DISCLOSURE

One embodiment of the present disclosure is intended to provide an apparatus and a method for a 3D text messaging service capable of converting an ordinary text message to a 3D message and providing the converted 3D message.

One embodiment of the present disclosure is intended to provide an apparatus and a method for a 3D text messaging service capable of providing a fun user experience and conveying the meaning of text with more emphasis and more effectively by converting the text into an XR message using a 3D effect associated with the content and context of the text and allowing a user to receive and view the converted XR message.

One embodiment of the present disclosure is intended to provide an apparatus and a method for a 3D text messaging service capable of supporting a new business model by inserting an advertisement associated with message context and providing a message sender and recipient with a reward for the insertion of the advertisement.

Among embodiments, an apparatus for a 3D text messaging service comprises a text analyzer analyzing a text message input and transmitted through a sender terminal and recognizing text content and message context; an associated image generator determining an image associated with the recognized message context and generating an image associated with the text message; an effect generator generating a 3D effect to be included in the text and associated image according to the recognized text content; and an XR message converter integrating the text, the associated image, and the 3D effect, converting the integrated content into an extended reality (XR) message, and providing the XR message to a receiver terminal.

The text analyzer may extract a word through semantic analysis of text included in the text message and recognize contextual information corresponding to the extracted word through an AI-based learning model.

The associated image generator may determine an image including at least one of a background, an avatar, a character, and an emoticon associated with the recognized message context.

When a unique avatar is selected for each sender, the associated image generator may determine the corresponding unique avatar as an associated image for a text message transmitted from the sender terminal.

The associated image generator may generate a sender avatar, analyze a sender image captured through a camera, and reflect the sender's pose on the sender image to the sender avatar.

The associated image generator may determine an advertisement associated with the recognized message context as an associated image when a sender and a receiver agree to receive advertisements in advance.

The 3D effect generator may determine at least one of a 3D effect, a fade effect, a text size and color conversion effect, an animation effect, and a floating effect according to the recognized text context and apply the determined effect to the text and the associated image.

Among embodiments, an apparatus for a 3D text messaging service may further include an advertisement reward unit providing a reward for receiving an advertisement when the advertisement is inserted into the XR message.

Among embodiments, a method for a 3D text messaging service may comprise recognizing text content and message context by analyzing a text message transmitted through a sender terminal; generating an image associated with the text message by determining at least one of a background, an avatar, an emoticon, and an advertisement associated with the text content and message context; generating at least one of a 3D effect, an AR/VR effect, a text size/color conversion effect, an animation effect, and a hologram effect for the text message and associated image; and converting the text message with an added effect into one 3D extended reality (XR) message by integrating the text message with the associated image and displaying the converted 3D XR message on a receiver terminal.

The present disclosure may provide the following effects. However, since it is not meant for a specific embodiment to provide all of or only the following effects, the technical scope of the present disclosure should not be regarded as being limited by the specific embodiment.

An apparatus and a method for a 3D text messaging service according to one embodiment of the present disclosure may convert an ordinary text message into a 3D message and provide the converted 3D message so that even an XR device may receive and view the text message.

An apparatus and a method for a 3D text messaging service according to one embodiment of the present disclosure may provide a fun user experience and convey the meaning of text with more emphasis and more effectively by converting the text into an XR message using a 3D effect associated with the content and context of the text and allowing a user to receive and view the converted XR message.

An apparatus and a method for a 3D text messaging service according to one embodiment of the present disclosure may support a new business model by inserting an advertisement associated with message context and providing a message sender and recipient with a reward for the insertion of the advertisement.

### BRIEF DESCRIPTION OF THE DRAWINGS

FIG. 1 illustrates a 3D text messaging service system according to the present disclosure.

FIG. 2 illustrates a physical structure of an apparatus for a text messaging service of FIG. 1.

FIG. 3 illustrates a functional structure of an apparatus for a text messaging service of FIG. 1.

FIG. 4 is a flow diagram illustrating a method for a 3D text messaging service according to the present disclosure.

FIG. 5 illustrates a process for a 3D text messaging service according to one embodiment of the present disclosure.

FIG. 6 illustrates a text message transmitted and received to and from a sender terminal and a receiver terminal according to one embodiment of the present disclosure.

### DESCRIPTION OF EXEMPLARY EMBODIMENTS

The description of the present disclosure is merely an example for structural or functional explanation, and the scope of the present disclosure should not be construed as being limited to the embodiments set forth herein. That is, the embodiments are to be construed as being variously embodied and having various forms, so that the scope of the present invention should be understood to include equivalents capable of realizing technical ideas. Also, the purpose or effect of the present invention should not be construed as limiting the scope of the present invention, since it does not mean that a specific embodiment should include all or only such effect.

Meanwhile, the meaning of the terms described in the present application should be understood as follows.

The terms “first”, “second”, and the like are intended to distinguish one element from another, and the scope of the right should not be limited by these terms. For example, the first component may be referred to as a second component, and similarly, the second component may also be referred to as a first component.

When one element is described as being “connected” to another element, it shall be construed as being connected or accessed to another element directly but also as possibly having yet another element in between. On the other hand, if one element is described as being “directly connected” to another element, it shall be construed that there is no other element in between. This is also true of other expressions for explaining a relationship between elements, i.e., “between” and “directly between” or “adjacent to” and “directly adjacent to”.

Unless clearly used otherwise, expressions in the singular number include a plural meaning. In the present description, an expression such as “comprising”, “including”, or “having” is intended to designate a characteristic, a number, a step, an operation, an element, a part or combinations thereof, and shall not be construed to preclude any presence or possibility of one or more other characteristics, numbers, steps, operations, elements, parts or combinations thereof.

Identification codes (e.g., a, b, and c) of each step are merely used for better comprehension and ease of description, not indicating a specific order of the steps, and the steps may be performed in a different order from a described order, unless clearly limited otherwise. Specifically, the steps may be performed in the same order as the described order, may substantially simultaneously be performed, or may be performed in the reverse order.

The present disclosure may be embodied as computer-readable code in a computer readable recording medium, and the computer-readable recording medium may include all kinds of recording devices for storing data that is readable by a computer system. Examples of the computer-readable recording medium include a ROM, a RAM, a CD-ROM, a magnetic tape, a floppy disk, an optical data storage device, and the like. Further, the computer-readable recording medium may be distributed to a computer system connected via a network and thus store and execute computer-readable code in a distributed manner

Unless otherwise defined, all terms used herein have the same meaning as how they are generally understood by those of ordinary skill in the art to which the disclosure pertains. Any term that is defined in a general dictionary shall be construed to have the same meaning in the context of the relevant art, and, unless otherwise defined explicitly, shall not be interpreted to have an idealistic or excessively formalistic meaning.

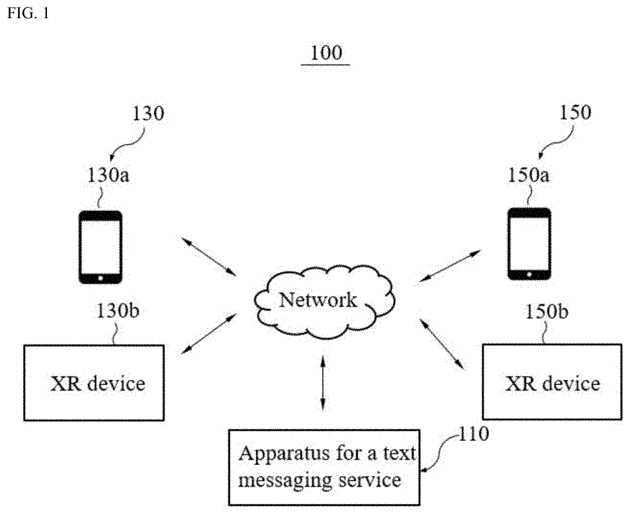

FIG. 1 illustrates a 3D text messaging service system according to the present disclosure.

Referring to FIG. 1, a 3D text messaging service system 100 may comprise an apparatus for a text messaging service 110, a sender terminal 130, and a receiver terminal 150, which may be connected to each other through a wireless network.

The apparatus for a text messaging service 110 may be implemented using a server corresponding to a computer or a program capable of providing a service of transmitting and receiving a text message between the sender terminal 130 and the receiver terminal 150. In one embodiment, the apparatus for a text messaging service 110 may be executed by installing an application operating in conjunction with a mobile communication service provider or a messenger system such as Kakao. The apparatus for a text messaging service 110 may provide mobile application software to user terminals and may provide a web-based platform, such as a website.

The apparatus for a text messaging service 110 may convert a text message transmitted by the sender terminal 130 into the text of a 3D form and provide the converted text message to be displayed in a 3D form on the receiver terminal 150. In one embodiment, the apparatus for a text messaging service 110 may recognize the content and context of a message through text analysis, determine a 3D effect relevant to the recognized message content and context, generate an effect image, and provide information on the determined 3D form and the generated effect image to the receiver terminal 150 together with the text message. The apparatus for a text messaging service 110 may automatically convert a text message into a 3D message and transmit the converted text message to the receiver terminal 150.

In one embodiment, the apparatus for a text messaging service 110 may insert an advertisement relevant to the message content and context to a text message. At this time, the apparatus for a text messaging service 110 may provide a reward to a sender and a receiver in return for receiving the advertisement. The apparatus for a text messaging service 110 may be connected to the sender terminal 130 and the receiver terminal 150 through a wireless network such as the Bluetooth, Wi-Fi, and 5G communication and may transmit and receive an XR text message through the network. The apparatus for a text messaging service 110 may be connected to an external advertiser system through the network.

The sender terminal 130 and the receiver terminal 150 may be connected to the apparatus for a 3D text messaging service 110 through the network and may be implemented by computing devices capable of transmitting and receiving text messages with each other. For example, the sender terminal 130 and the receiver terminal 150 may be implemented by a device equipped with a messenger function, such as a smartphone, a Personal Digital Assistant (PDA), a tablet PC, and a notebook computer.

In one embodiment, the sender terminal 130 and the receiver terminal 150 may include a smartphone 130a, 150a and an XR device 130b, 150b. The sender's XR device 130b may be paired with the smartphone 130a to check the converted XR message for a text message to be transmitted from the smartphone 130a. The receiver's XR device 150b may be paired with the smartphone 150a to display the XR message received from the smartphone 150a. Here, the XR device 130b, 150b may be basically implemented using a Head Mounted Display (HMD)/headset terminal, or VR/AR glasses, which is not necessarily limited to the specific example and may be implemented using various devices capable of reproducing AR/VR images.

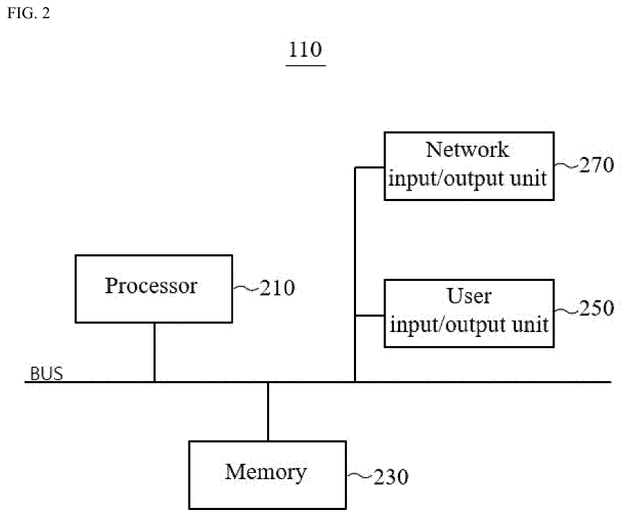

FIG. 2 illustrates a physical structure of an apparatus for a text messaging service of FIG. 1.

Referring to FIG. 2, the apparatus for a text messaging service 110 may comprise a processor 210, a memory 230, a user input/output unit 250, and a network input/output unit 270.

The processor 210 may execute a procedure for processing the respective steps of the operation process of the apparatus for a text messaging service 110, manage the memory 230 read or written throughout the process, and schedule a synchronization timing between a volatile memory and a non-volatile memory in the memory 230. The processor 210 may control the overall operation of the apparatus for a text messaging service 110 and, being electrically connected to the memory 230, the user input/output unit 250, and the network input/output unit 270, may control a data flow between them. The processor 210 may be implemented by the central processing unit (CPU) of the text messaging service device 110.

The memory 230 may include an auxiliary storage device implemented by a non-volatile memory such as a solid-state drive (SSD) or a hard disk drive (HDD) and used for storing the overall data required for the apparatus for a text messaging service 110 and may include a main storage device implemented by a volatile memory such as a random-access memory (RAM).

The user input/output unit 250 may include an environment for receiving a user input and an environment for outputting specific information to the user. For example, the user input/output unit 250 may include an input device including an adaptor such as a touchpad, a touch screen, an on-screen keyboard, or a pointing device; and an output device including an adaptor such as a monitor or a touch screen. In one embodiment, the user input/output unit 250 may correspond to a computing device connected through remote access, for which case the apparatus for a text messaging service 110 may be operated as a separate server.

The network input/output unit 270 may include an environment for connecting to an external device or system through a network and include, for example, an adaptor for communication such as Local Area Network (LAN), Metropolitan Area Network (MAN), Wide Area Network (WAN), and Value Added Network (VAN).

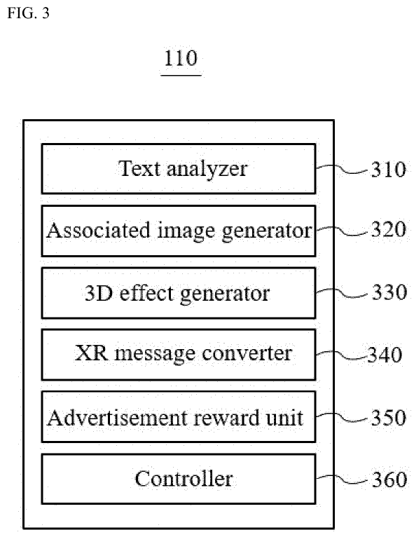

FIG. 3 illustrates a functional structure of an apparatus for a text messaging service of FIG. 1.

Referring to FIG. 3, the apparatus for a text messaging service 110 may comprise a text analyzer 310, a 3D effect generator 320, an associated image generator 330, an XR message converter 340, an advertisement reward unit 350, and a controller 360.

The text analyzer 310 may analyze a text message transmitted from the sender terminal 110 to recognize the text content and message content. Text is a kind of unstructured data, for which an analysis and processing process may be performed to extract meaningful information through text mining. The text analyzer 310 may recognize the text content and message context conveyed in a text message using at least one of various methods for analyzing text, such as morpheme (word) analysis, string analysis, key phrase extraction, vector space modeling, co-occurring word extraction, topic modeling, text sentiment analysis, semantic network analysis, and machine learning.

In one embodiment, the text analyzer 310 may extract a morpheme, the smallest unit of meaning, or a word from the input text and obtain text content or context information based on the extracted word or morpheme. Here, the text analyzer 310 may extract words conveyed in a text message transmitted from the sender terminal 110 through a pre-trained data recognition model or extract words for the text message through semantic analysis of the text contained in the text message. For example, the text analyzer 310 may extract words such as “Christmas” or “winter sea” from a text message of “Let's go see the winter sea together this Christmas—” through an AI-based pre-trained data recognition model or semantic analysis. The text analyzer 310 may recognize the contextual information corresponding to the extracted words. At this time, the text analyzer 310 may recognize the contextual information corresponding to the extracted words through the pre-trained data recognition model or pre-stored word-context information matching table. For example, the text analyzer 310 may obtain “Christmas trip,” “Christmas weather,” “winter sea scenery,” or “seaside cafe” as the contextual information corresponding to the words such as “Christmas” and “winter sea.” Also, the text analyzer 310 may quantify the emotion ratio of a text message to be analyzed based on an emotion dictionary and perform emotion analysis such as joy, depression, anger, or sadness.

The associated image generator 320 may determine an image that may be associated with a text message based on the content and context information of the text. Here, an associated image may be classified into one of the categories such as background, avatar, character, and emoticon and may include various images according to a keyword for each category along with an association ratio with the keyword. For example, when a text message contains the word “winter,” the associated image generator 320 may determine a background image and a snowman image that may express winter as associated images using winter as a keyword from the background and character categories. If there is a plurality of associated images, the associated image generator 320 may automatically generate an image having the highest association as the associated image based on the association ratio.

In one embodiment, the associated image generator 320 may select a unique avatar for each sender and determine to always express the pre-selected unique avatar for a text message transmitted from the sender terminal 110. The associated image generator 320 may determine to display an avatar that changes according to the context information of a text message. Here, the avatar may take an action in which an emotional expression and a gesture are combined according to the message context. The associated image generator 320 may generate a sender avatar. The associated image generator 320 may determine the pose of a generated sender avatar by receiving a sender image captured through a camera and recognizing the sender's pose through pose estimation. Here, the camera may be mounted on the sender terminal 130. In one embodiment, the associated image generator 320 may analyze the sender's pose using machine learning, deep learning, or the like, reflect the analyzed pose of the sender on the corresponding avatar, and transmit the avatar in a pose similar to the sender's pose.

In one embodiment, the associated image generator 320 determines an advertisement as an associated image based on context information so that the advertisement may be inserted when a text message is transmitted. The associated image generator 320 may be executed under the user's consent in advance.

The 3D effect generator 330 may determine a 3D effect related to the text and an associated image. The 3D effect generator 330 may generate 3D text by rendering the text to produce a 3D lettering effect according to the text content. The 3D effect generator 330 may include a 3D text effect, a fade effect, a text size and color conversion effect, an animation effect, and a floating effect. The 3D effect generator 330 may create a text track on a timeline to add fade-in and fade-out effects of gradually appearing and disappearing text. The 3D effect generator 330 may change the font size and color of a specific part of the text to give an effect of emphasizing the corresponding character. The 3D effect generator 330 may generate an animation code for expressing the emotion of an avatar. The animation code may include expression and motion animation codes defined for each emotion. For example, when the text context contains the word “sadness,” the expression animation code may be defined as a movement that causes the avatar to make a crying expression, and the motion animation code may be defined as a movement that causes the avatar to rub the eyes with both hands. When generating an animation code, the 3D effect generator 330 may also generate information on the time the animation code is implemented.

The 3D effect generator 330 may generate an AR or VR effect by applying AR, VR, or AI technology to the associated image or may generate a hologram effect so that an avatar or an emoticon is expressed in a 3D shape.

The XR message converter 340 may generate one XR message by combining a text message, an associated image, and a 3D effect. In one embodiment, the XR message converter 340 may transmit a text message, an associated image, and 3D effect information to the receiver terminal 150. In one embodiment, the XR message converter 340 may apply a determined 3D effect to a text message and an associated image, generate one image message by superimposing the text on the associated image, and transmit the generated image message to the receiver terminal 150. At this time, the XR message converter 340 inserts text at the same level as the maximum depth value of the 3D associated image so that the depth value of the inserted text matches the maximum depth value of a given depth map and the associated image is combined with the text, by which the text message may be viewed through an extended reality (XR) device 150b.

When an advertisement is inserted into an XR message, the advertisement reward unit 350 may provide a reward in return for the transmission and reception of the advertisement to a sender who has consented to the insertion of an advertisement and a user who has received the XR message to which the advertisement has been inserted and watched the advertisement. In one embodiment, the advertisement reward unit 350 may provide a downloadable discount coupon that may be used when the user visits an advertiser company according to the content of the advertisement. The advertisement reward unit 350 may check the number of advertisement transmission/reception times and may settle tokens or cash points according to the number of advertisement transmission/reception times in units of a predetermined period. For example, the advertisement reward unit 350 may provide compensation such as a communication fee discount, a product discount related to a communication service provider, and a free ticket.

The controller 360 may control the overall operation of the apparatus for a 3D text messaging service 110 and manage a control flow or a data flow between the text analyzer 310, the associated image generator 320, the 3D effect generator 330, the XR message converter 340, and the advertisement reward unit 350.

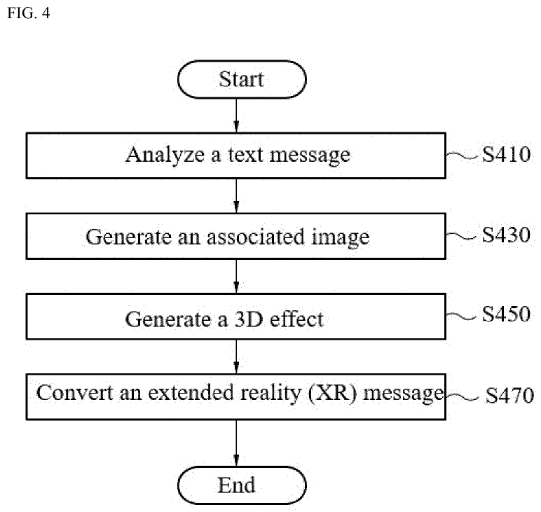

FIG. 4 is a flow diagram illustrating a method for a 3D text messaging service according to the present disclosure.

Referring to FIG. 4, an apparatus for a text messaging service 110 may analyze a text message transmitted from the sender terminal 130 and recognize the text content and message context through the text analyzer 310, S410. The apparatus for a text messaging service 110 may determine an image such as a background, an avatar, and an emoticon that may be associated with the text content and message context through the associated image generator 320 and generate an associated image of the text message by determining an advertisement with the content associated with the message context when a sender or a receiver consents to the insertion of an advertisement S430.

Also, the apparatus for a text messaging service 110 may generate a 3D text message by adding a 3D effect, an AR/VR effect, a text size/color conversion effect, an animation effect, and a hologram effect to the text message and the associated image through the 3D effect generator 330, S450. The apparatus for a text messaging service 100 may convert a text message and an associated image into one 3D XR message by integrating the text message into the associated image through the XR message converter 340, S470.

Afterward, the apparatus for a text messaging service 110 may transmit an XR message to the receiver terminal 150 to display the XR message through the receiver terminal 150. When displaying a received XR message on the display, the receiver's smartphone 150a or the XR device 150b paired with the smartphone 150a may display a text message along with a background or an avatar associated with the text message and may control the visual appearance of the avatar based on an animation code. Meanwhile, a method for a 3D text messaging service according to the present disclosure may be performed through the XR device 150b, according to which the XR device 150b may receive a message.

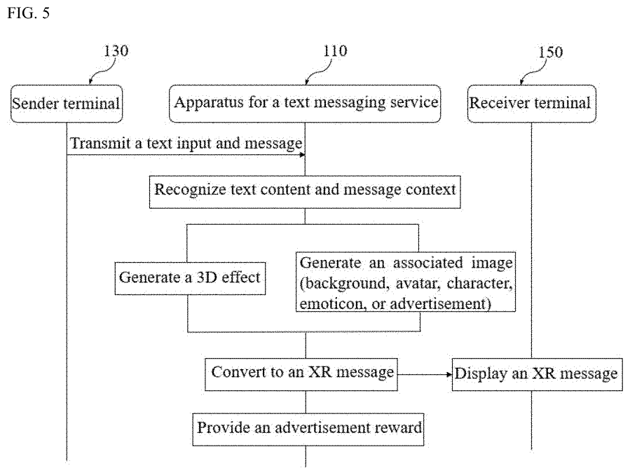

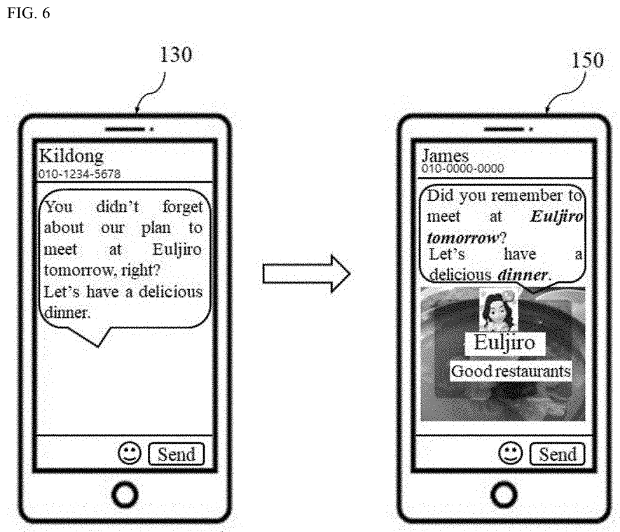

FIG. 5 illustrates a process for a 3D text messaging service according to one embodiment of the present disclosure, and FIG. 6 illustrates a text message transmitted and received to and from a sender terminal and a receiver terminal according to one embodiment of the present disclosure.

In FIG. 5, the sender terminal 130 may include a messenger application, and the sender may designate the receiver terminal 150 by executing the messenger application, input a text message, and transmit the input text message (refer to the example of FIG. 6).

In FIG. 5, the apparatus for a text messaging service 110 may correspond to a messenger service providing server capable of transmitting and receiving a message between the sender terminal 130 and the receiver terminal 150 or an application that may be executed in the sender terminal 130 or the receiver terminal 150. The apparatus for a text messaging service 110 may recognize the text content and the message context by analyzing the text transmitted from the sender terminal 130. The apparatus for a text messaging service 110 may generate an associated image by determining an image such as a background, an avatar, a character, an emoticon, or an advertisement that may be associated with the text content and the message context recognized through analysis of the text message and determine a 3D effect to apply. The apparatus for a text messaging service 110 may convert the text, the associated image, and the 3D effect information into one XR message by combining them and may transmit the XR message to the receiver terminal 150.

The receiver terminal 150 may be installed with an XR message conversion application and may display a received XR message on the display by activating the application. At this time, the receiver terminal 150 may apply a 3D effect to the text and the associated image included in the XR message and merge the 3D effect with the text and the associated image; display the background and the avatar associated with the text when displaying the text on the display; and make the avatar appear overlaid with the text by changing the expression and the movement of the avatar.

The device may provide a message sender and receiver a reward for receiving an advertisement.

The apparatus and method for a 3D text messaging service according to one embodiment may further emphasize and effectively convey the fun element and the meaning of the text by combining the text sent by a sender with various effects to be viewed by a receiver; present a new business model by inserting an advertisement associated with the message context; receive messages through XR devices; and be utilized as a communication means for providing an effective and new experience in various fields such as work collaboration, education, and communication in a virtual space.

Although the present disclosure has been described with reference to preferred embodiments given above, it should be understood by those skilled in the art that various modifications and variations of the present disclosure may be made without departing from the technical principles and scope specified by the appended claims below.

[Description of symbols]

| | |
|---|---|
| 100: System for a 3D text messaging service | |
| 110: Apparatus for a text messaging service | |
| 130: Sender terminal | 150: Receiver terminal |
| 130a, 150a: Smartphone | 130b, 150b: XR device |
| 210: Processor | 230: Memory |
| 250: User input/output unit | 270: Network input/output unit |
| 310: Text analyzer | 320: Associated image generator |
| 330: 3D effect generator | 340: XR message converter |
| 350: Advertisement reward unit | 360: Controller |

What is claimed is:

1. An apparatus for a 3D text messaging service, comprising:
a text analyzer analyzing a text message input and transmitted through a sender terminal and recognizing text content and message context;
an associated image generator determining an image associated with the recognized message context and generating an image associated with the text message;
an effect generator generating a 3D effect to be included in the text and associated image according to the recognized text content; and
an XR message converter integrating the text, the associated image, and the 3D effect, converting the integrated content into an extended reality (XR) message, and providing the XR message to a receiver terminal.

2. The apparatus of claim 1, wherein the text analyzer extracts a word through semantic analysis of text included in the text message and recognizes contextual information corresponding to the extracted word through an AI-based learning model.

3. The apparatus of claim 1, wherein the associated image generator determines an image including at least one of a background, an avatar, a character, and an emoticon associated with the recognized message context.

4. The apparatus of claim 3, wherein, when a unique avatar is selected for each sender, the associated image generator determines the corresponding unique avatar as an associated image for a text message transmitted from the sender terminal.

5. The apparatus of claim 4, wherein the associated image generator generates a sender avatar, analyzes a sender image captured through a camera, and reflects the sender's pose on the sender image to the sender avatar.

6. The apparatus of claim 1, wherein the associated image generator determines an advertisement associated with the recognized message context as an associated image when a sender and a receiver agree to receive advertisements in advance.

7. The apparatus of claim 1, wherein the 3D effect generator determines at least one of a 3D effect, a fade effect, a text size and color conversion effect, an animation effect, and a floating effect according to the recognized text context and apply the determined effect to the text and the associated image.

8. The apparatus of claim 6, further including an advertisement reward unit providing a reward for receiving an advertisement when an advertisement is inserted into the XR message.

9. A method for a 3D text messaging service, comprising:
recognizing text content and message context by analyzing a text message transmitted through a sender terminal;
generating an image associated with the text message by determining at least one of a background, an avatar, an emoticon, and an advertisement associated with the text content and message context;
generating at least one of a 3D effect, an AR/VR effect, a text size/color conversion effect, an animation effect, and a hologram effect for the text message and associated image; and
converting the text message with an added effect into one 3D extended reality (XR) message by integrating the text message with the associated image and displaying the converted 3D XR message on a receiver terminal.
